(19) United States
(12) Patent Application Publication
(10) Pub. No.: US 2025/0292635 A1
(43) Pub. Date: Sep. 18, 2025

(54) INFORMATION PROCESSING DEVICE

(71) Applicant: TOYOTA JIDOSHA KABUSHIKI KAISHA, Toyota-shi (JP)

(72) Inventors: Masato ENDO, Nagoya-shi (JP); Kota WASHIO, Suto-gun (JP); Shuhei MANABE, Toyota-shi (JP)

(73) Assignee: TOYOTA JIDOSHA KABUSHIKI KAISHA, Toyota-shi (JP)

(21) Appl. No.: 19/070,957

(22) Filed: Mar. 5, 2025

(30) Foreign Application Priority Data
Mar. 12, 2024 (JP) 2024-037889

(51) Int. Cl. G07C 5/08

(52) U.S. Cl. CPC G07C 5/0816

(57) ABSTRACT

An information processing device according to an aspect of the present disclosure is configured to set a notification format of information according to a result of diagnosing a driving characteristic of a user from driving data related to driving of a vehicle, and notify the user of information related to a result of diagnosing the driving characteristic according to the set notification format.

### CROSS-REFERENCE TO RELATED APPLICATION

This application claims priority to Japanese Patent Application No. 2024-037889 filed on Mar. 12, 2024, incorporated herein by reference in its entirety.

### BACKGROUND

### 1. Technical Field

The present disclosure relates to an information processing device.

### 2. Description of Related Art

Japanese Unexamined Patent Application Publication No. 2023-103727 (JP 2023-103727 A) proposes a presentation device that presents driving support information. Specifically, the presentation device performs a driving diagnosis for a driving operation by a driver based on vehicle information acquired from a sensor. The presentation device determines similarity related to driving based on the vehicle information, the result of the driving diagnosis, and data on other drivers stored in a storage device. Then, the presentation device presents driving support information for supporting driving based on the determined similarity and the result of the driving diagnosis.

### SUMMARY

An object of the present disclosure is to provide a technique of improving the efficiency in providing information.

An aspect of the present disclosure provides an information processing device including a control unit. The control unit is configured to: set a notification format according to a result of diagnosing a driving characteristic of a user from driving data related to driving of a vehicle; and
notify the user of information associated with the result of diagnosing the driving characteristic according to the set notification format.

According to the present disclosure, it is possible to improve the efficiency in providing information.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically illustrates an example of a scene to which the present disclosure is applied;

FIG. 2A schematically illustrates a configuration of a notification format according to an embodiment of the present disclosure;

FIG. 2B schematically illustrates a configuration of a notification format according to an embodiment of the present disclosure;

FIG. 3 schematically illustrates an example of a hardware configuration of a server device of the present disclosure;

FIG. 4 illustrates an exemplary process of the disclosed server-device; and

FIG. 5 schematically illustrates another example of a scene to which the present disclosure is applied.

### DETAILED DESCRIPTION OF EMBODIMENTS

According to the conventional method, the driving characteristics of the user (driver) can be diagnosed by information obtained from a vehicle, a terminal, or the like, and information on the result of the diagnosis can be provided (JP 2023-103727 A, etc.). The information related to the diagnosis result is, for example, the diagnosis result itself, driving support information corresponding to the diagnosis result, or the like. By feeding back the information on the diagnosis result of the driving characteristic to the user, it is possible to expect an action change such as an improvement in the operation technology and an update of the vehicle equipment. However, the acceptability of the information provided differs for each user. Therefore, even if the information on the diagnosis result of the driving characteristic is provided, it is not always accepted by the user.

On the other hand, the information processing device according to the first aspect of the present disclosure includes a control unit. The control unit is configured to set a notification format according to a result of diagnosing a driving characteristic of the user from driving data related to driving of the vehicle, and to notify the user of information related to a result of diagnosing the driving characteristic according to the set notification format.

One of the factors that determine the acceptability of information is the user's personality. For example, when emotional stability is high, it is estimated that the user is highly likely to accept information even if information is notified frequently. On the other hand, when the emotion stability is low, if information is frequently notified, it is presumed that the user is highly likely not to accept the information. According to references 1 (Ryusei Kimura, Shogo Okada, Takahiro Tanaka, Shuhei Manabe, “Estimation of Driver Characteristics for Personalization of Driver Assistance Systems,” Society of Automotive Engineers of Japan, Inc., 2022 JSAE Annual Congress (Autumn) Proceedings, Oct. 7, 2022, literature number 20226249, pp. 1-6), there is a knowledge that users' characteristics are correlated with driving characteristics.

In the first aspect of the present disclosure, the notification format of the information is set according to the diagnosis result of the driving characteristic. At this time, as described above, there is a correlation between the driving characteristic and the personality, since the personality can affect the acceptability of the information, it is possible to expect that a notification form that conforms to the acceptability of the information is set from the diagnosis result of the driving characteristic. As a result, it is possible to provide information compatible with the acceptability of the user, and as a result, it is possible to improve the efficiency of the information provision.

As another aspect of the information processing device according to the above aspect, one aspect of the present disclosure may be an information processing method that realizes all or a part of each of the above-described constituent elements, or may be a program. The program may be stored in a machine-readable storage medium such as a computer. Here, the machine-readable storage medium is a medium that stores information such as a program by electrical, magnetic, optical, mechanical or chemical action.

### 1 Application Example

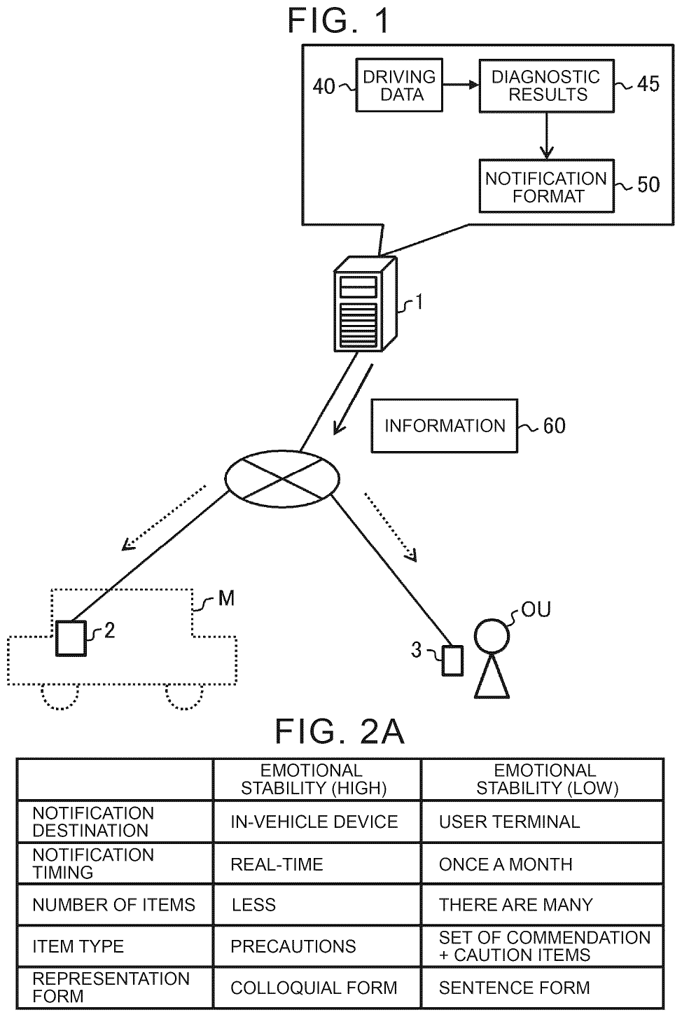

FIG. 1 schematically illustrates an example of a scene to which the present disclosure is applied. The server device 1 according to the present embodiment is one or more computers configured to change the notification format according to the diagnosis result of the driving characteristic of the user. The server device 1 is an example of the information processing device of the present disclosure. In the present embodiment, the server device 1 sets the notification format 50 according to the result (diagnosis result) 45 of diagnosing the driving characteristic of the user OU from the driving data 40 related to the driving of the vehicle M. According to the set notification format 50, the server device 1 notifies the user OU of the information 60 related to the result 45 of diagnosing the driving characteristic.

In FIG. 1, the in-vehicle device 2 and the user terminal 3 are examples of notification destination candidates for the information 60. The in-vehicle device 2 is one or more computers mounted on the vehicle M of the user OU. The user terminal 3 is one or more computers held in the user OU. The user terminal 3 may include, for example, a smart phone, a tablet terminal, a laptop PC (Personal Computer), and the like. In the present embodiment, when the user OU holds a plurality of terminals, the plurality of terminals may be regarded as one user terminal 3.

As described above, there is a correlation between the driving characteristics and the personality, and the personality may affect the acceptability of the information. Therefore, in the present embodiment, it is possible to expect the server device 1 to set the notification format 50 conforming to the acceptability of the user OU in accordance with the result 45 of diagnosing the driving characteristic. Accordingly, the information 60 can be provided in the notification format 50 that conforms to the acceptability of the user OU, and consequently, the information can be efficiently provided. Incidentally, the efficiency of the information provision may include, for example, a reduction in useless information provision (that the provided information is ignored).

### Driving Data

The driving data 40 relates to driving of a driver. The configuration of the driving data 40 is not particularly limited as long as it includes information capable of diagnosing the driving characteristics, and may be appropriately determined according to the embodiment. In an example, the driving data 40 may include a speed, an acceleration, a jerk, a state of a stop lamp, a brake pressure, a brake pressure speed, an accelerator operation amount, a steering angle, a steering angular velocity, a state (left and right) of a turn lamp, and the like. In one example, the driving data 40 may include yaw angle, yaw rate, energy consumption (fuel consumption, electricity consumption), line-of-sight position (horizontal, vertical), diagonal angle (pitch, yaw, roll), etc.

The driving data 40 may be appropriately collected from sensors such as an in-vehicle sensor, an in-vehicle device 2, and a user terminal 3 of the vehicle M. The sensors may include, for example, an image sensor, a position sensor, an acceleration sensor, a gyro sensor, a pedal angle sensor, a pedal force sensor, a brake pressure sensor, a steering angle sensor, and a radar. The sensor may include, for example, a LiDAR (Light Detection And Ranging), a sonar (ultrasonic sensor), an infra-red sensor, an onboard sensor, and the like. Each value of the driving data 40 may be a raw value obtained by the sensor or a value (processed value) calculated by analyzing the value obtained by the sensor. Further, the timing and the collection period for starting the collection of the driving data 40 may not be particularly limited, and may be appropriately determined according to the embodiment.

### Operating Characteristics

The driving characteristic represents a property of the driving behavior of the driver. The item of the driving characteristic to be diagnosed is not particularly limited as long as the item includes an item in which the character of the driver can be expressed, and may be appropriately defined according to the embodiment. In one example, the driving characteristic may be defined by a characteristic quantity of the driving scene. The driving scene and the feature amount may be selected as appropriate. Driving scenes may include, for example, intersections, lane changes, curves, launches, parking, etc. The feature quantity may include statistics such as a mean value, a median value, a variance, a standard deviation, a maximum value, a minimum value, a skewness, a kurtosis, and the like. It should be noted that the definition of the operating characteristics is not limited to such an example. In another example, the driving characteristic may be represented by a score indicating the quality instead of or together with the feature value. The criterion of quality may be determined as appropriate, and a score may also be defined as appropriate in accordance with the criterion.

The driving characteristics may be appropriately diagnosed from the driving data 40. A known method may be employed as the diagnostic method. At least one of a rule-based model and a trained machine learning model may be used to diagnose driving characteristics.

The rule-based model is configured to derive an inference result (in the present embodiment, a diagnosis result of an operating characteristic) from a given input according to a rule. The rule may be set as appropriate. The information processing according to the rule may include, for example, conditional branching, calculation of a statistic, and the like. As an example, when the driving characteristics are defined for each driving scene, the driving scene can be appropriately extracted from the values of the driving data 40. For example, in the above-mentioned reference document 1, a section in which the yaw angular velocity is equal to or greater than 3.0 [deg/sec] and the change amount of the yaw angle is equal to or greater than 20 [deg] (excluding a section in which the change amount of the yaw angle is smaller than or equal to 60 [deg or the smallest value of the vehicle speed is equal to or greater than 60 [km/h]) is detected as a scene of the intersection. Then, the scenes of the intersection (left turn) and the intersection (right turn) are distinguished according to the direction of the steering angle. The lane change and curve scenes can likewise be extracted based on the values of the driving data 40. Accordingly, the rule-based model may be configured to diagnose the driving characteristic by extracting a section of each driving scene in which the value of the driving data 40 satisfies the condition, and calculating a statistic of the driving data 40 in the extracted section.

On the other hand, the machine learning model is configured to have one or more arithmetic parameters that can be adjusted by machine learning. The one or more computational parameters are used to compute the intended inference (in this embodiment, the diagnosis of the operating characteristics). The machine learning model may include, for example, a neural network, a regression model, a decision tree model, a support vector machine, and other functional expressions (arithmetic models). The method of machine learning may be appropriately selected according to a model of machine learning to be adopted (for example, an error back propagation method or the like).

Machine learning is the use of training samples to adjust (optimize) the values of computational parameters. Typically, a trained model can be generated by performing supervised learning using a plurality of learning data sets each composed of a combination of input samples (training samples) and output samples (teacher signals, labels). For example, the input samples are samples of the driving data 40 and the output samples are the true values of the corresponding diagnostic results. The true value of the diagnosis result may be given as appropriate. In supervised learning, the values of the computational parameters of the machine learning model may be adjusted so that the output obtained from the machine learning model is adapted to the corresponding output samples by providing the input samples. However, the method of generating the trained model is not limited to such an example, and may be appropriately changed according to the embodiment. The learning data set is not limited to the above-described example, and may be appropriately selected according to the embodiment. For example, when an ability to perform intra-context learning is acquired, such as a large-scale language model, data other than the above may be used in the learning data set.

The computer that generates the diagnosis result 45 of the driving characteristic from the driving data 40 is not particularly limited, and may be appropriately selected according to the embodiment. The diagnosis result 45 may be generated, for example, by the server device 1 or by another computer other than the server device 1. The other computers may be, for example, the in-vehicle device 2, the user terminal 3, or other computers (such as server devices other than the server device 1). In an example, the server device 1 may generate the diagnosis result 45 by acquiring the driving data 40 from the vehicle M, the in-vehicle device 2, the user terminal 3, and the like and analyzing the acquired driving data 40. Some processing on the driving data 40 may be executed by another computer such as the vehicle M, the in-vehicle device 2, and the user terminal 3, and the server device 1 may acquire the processing result and generate the diagnosis result 45 from the acquired processing result. In another example, the server device 1 may acquire the diagnosis result 45 from another computer.

### Notification Format

The notification format 50 defines a format for notifying the user OU of information including the information 60 related to the diagnosis result 45. The item of the notification format 50 to be set may be appropriately selected according to the embodiment. In an example, setting the notification format 50 may include setting at least one of a notification destination, a notification timing (notification frequency), a number of items of information to be notified, a type of an item of information to be notified, and a representation format.

The notification destination defines a device for notifying information. The notification destination may be set in units of terminals, such as the in-vehicle device 2 and the user terminal 3, or may be set in units of output devices, such as a display and a speaker. Different output devices of the same terminal may or may not be distinguished.

The notification timing defines a frequency at which information is notified. The notification timing may be set, for example, in real time (every action, every operation, etc.), once a day, once a few days, once a week, once a month, etc. The notification time may be set as appropriate. The notification time may be specified by the user OU or may be fixed in advance.

The number of information items defines the amount of information to be notified at one time. For example, the number of information items may be set according to the priority, such as all items, only main items, and the like. The priority may be appropriately set for each information item. In addition, the number of information items may be set to a specific number, for example, one, two, or the like.

The type of information item specifies the type of information to be notified. The type of the item of information may be set in accordance with the evaluation of the diagnosis result 45, for example, to notify only the attention item, to notify the attention item and the admiration item, and the like. Caution items correspond to diagnostic items of negative evaluation, and admiration items correspond to diagnostic items of positive evaluation.

The expression format defines the style of the sentence that constitutes the information. The expression format may be set to, for example, a colloquial format (soft sentence), a sentence-language format (hard sentence), or the like. The content of the information may be prepared in advance for each expression format, or may be appropriately generated by a generation model such as a large-scale language model.

The correspondence between the diagnosis result 45 of the driving characteristic and the setting of the notification format 50 may be determined as appropriate so as to match the acceptability of the user OU. For example, in a case where the acceptability of information is high, it is presumed that the user accepts the information even if the notification frequency of the information is high and the negative information is large. On the other hand, in a case where the acceptability of the information is low, it is estimated that the user does not accept the information unless the notification frequency of the information is lowered and the positive information is not actively notified. Therefore, for example, in a case where it is estimated that the acceptability of information is high from the diagnosis result 45 of the driving characteristic, the notification format 50 may be set such that the frequency of notifying the information is high and the information of the negative evaluation (attention item) is actively notified. On the other hand, in a case where it is estimated that the acceptability of the information is low from the diagnosis result 45 of the driving characteristic, the notification format 50 may be set such that the frequency of the notification of the information is low and the information of the positive evaluation (admiration item) is actively notified.

As a specific example, when it is estimated that the acceptability of the information of the user OU is high from the diagnosis result 45 of the driving characteristic, the notification timing may be set so that the notification frequency increases, such as in real time (for each action, for each driving), and the like. The notification destination may be set in the in-vehicle device 2 so that the notification with a high frequency can be easily received. In order to facilitate the improvement of the operation technology, the type of the information item may be narrowed down to the attention item. Accordingly, the number of information items may be set to be smaller. The representation format may be set to a colloquial format.

On the other hand, when it is estimated that the acceptability of the information of the user OU is low from the diagnosis result 45 of the driving characteristic, the notification timing may be set so that the notification frequency is reduced, such as once a week, once a month, or the like. The notification destination may be set in the user terminal 3 so as to be easy to receive a notification with a low frequency. In order to make it easier to look at the information of the attention item, the type of the information item may be set to include not only the attention item but also the admiration item. Accordingly, the number of information items may be set to be larger. The form of expressions can be set in the form of sentences.

### Setting Method

The process of the information processing for setting the notification format 50 from the diagnosis result 45 of the driving characteristic is not particularly limited, and may be appropriately selected according to the embodiment. In one embodiment, the server device 1 may estimate the personality of the user OU from the diagnosis result 45 of the driving characteristic, and set the notification format 50 according to the personality of the estimated user OU. At least one of a rule-based model and a trained model may be used for each process of estimation and setting. When the rule-based model is adopted, the correspondence between the character of the estimated user OU and the notification format 50 may be appropriately determined according to the embodiment.

The diagram 2A and the diagram 2B show exemplary notification formats 50 according to the character of the user OU. In Reference 1, correlations between personality items of the Automotive Accident Prevention Organization (NASVA) and driving properties are confirmed. Among NASVA personality items, the emotional stability has a correlation with the driving of the intersection, and the timing of the determination operation has a correlation with the driving of the intersection (left turn).

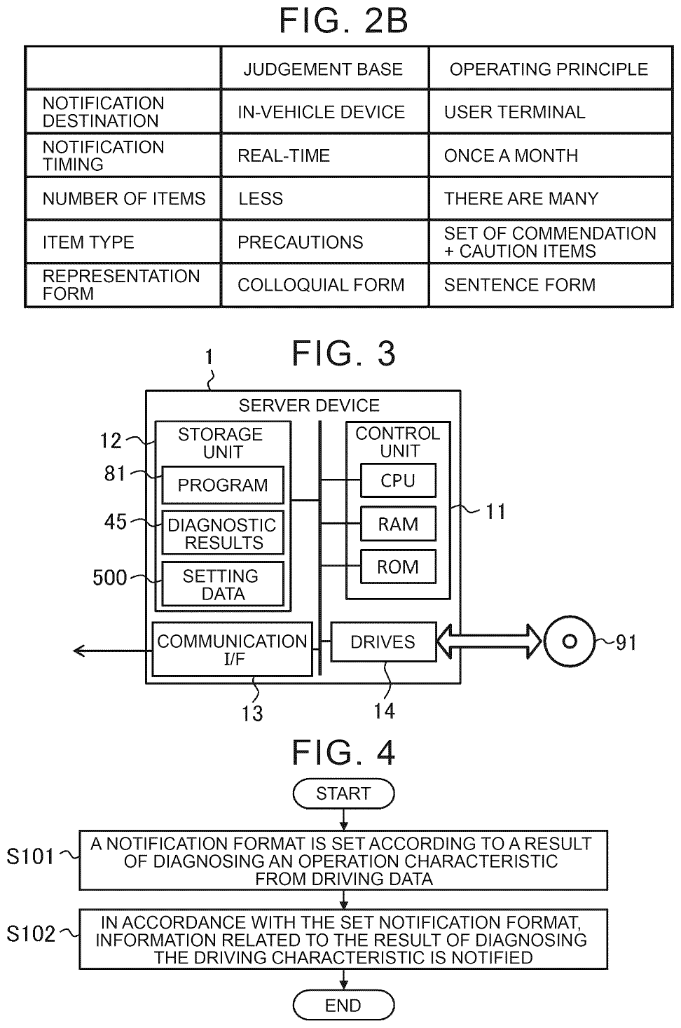

FIG. 2A shows an exemplary setting of the notification format 50 in a scene in which emotional stability is adopted as an index of a personality item for evaluating the acceptability of information. In one embodiment of FIG. 2A, when emotion is highly stable, the in-vehicle device 2 is selected as a notification destination, real-time is selected as notification timing, the number of information items is set to decrease, the type of information items is set to only attention items, and the oral form is selected as a representation form. On the other hand, when the emotion stability is low, the user terminal 3 is selected as the notification destination, and “once a month” is selected as the notification timing, the number of information items is set to be large, the type of the information item is set to the combination of the commendation item and the attention item, and the sentence word format is selected as the expression format. Whether the emotion stability is high or low may be determined as appropriate according to a threshold value or the like.

On the other hand, FIG. 2B shows an exemplary setting of the notification format 50 in a scene in which the timing of the determination operation is adopted as the index of the personality item for evaluating the acceptability of the information. In one embodiment of FIG. 2B, when the timing of the determination operation is based on the determination, the notification format 50 is set in the same manner as in the case where the emotion is highly stable. On the other hand, when the timing of the determination operation is the operation standard, the notification format 50 is set in the same manner as in the case where the emotion stability is low.

The server device 1 may estimate the stability of the emotion from the diagnosis result of the intersection among the obtained diagnosis results 45, and set the notification format 50 as shown in FIG. 2A of the drawing according to the estimated stability of the emotion. In addition, the server device 1 may estimate the timing of the determination operation from the diagnosis result of the intersection (left turn) among the obtained diagnosis results 45, and set the notification format 50 as shown in FIG. 2B in accordance with the estimated timing of the determination operation.

In an example in FIG. 2A and FIG. 2B, the type of the notification format 50 is two types. However, the number of types of the notification format 50 is not limited to two, and may be three or more. In addition, the correspondence between the personalities and the notification format 50 is not limited to the example in FIG. 2A and FIG. 2B, and may be appropriately determined according to the embodiment.

In addition, the personality item serving as an index for determining the notification format 50 may not be limited to the emotion stability and the timing of the determination operation. Other items of NASVA personality diagnostics may be employed as indicators. In addition, the personality item serving as an index may not be limited to the personality diagnosis item of NASVA. Other personality diagnostic items such as DSQ (Driving Style Questionnaire), WSQ (Workload Sensitivity Questionnaire), and psychological property (Big5) may be adopted as the personality items as indices. In addition, the personality item may be uniquely defined according to the type of the notification format 50 without using these existing personality diagnoses.

In addition, in the above-described setting methods, the server device 1 sets the notification format 50 through the estimation result of the character of the user OU from the diagnosis result 45 of the driving characteristic. However, the method of setting the notification format 50 is not limited to such an example. In another example, the server device 1 may directly set the notification format 50 from the diagnosis result 45 of the driving characteristic. For example, the server device 1 may set the notification format 50 as shown in FIG. 2A from the diagnosis result of the intersection among the obtained diagnosis results 45, or may set the notification format 50 as shown in FIG. 2B from the diagnosis result of the intersection (left turn). As described above, at least one of the rule-based model and the trained model may be used for the setting process. The correspondence between the diagnosis result 45 and the setting of the notification format 50 may be appropriately defined. The correspondence between the diagnosis result 45 and the setting of the notification format 50 may be appropriately adjusted in accordance with the estimation result of the character of the user OU derived from the diagnosis result 45.

### Information Provided

The content of the information 60 is not particularly limited as long as it is related to the diagnosis result 45 of the driving characteristic, and may be appropriately determined according to the embodiment. The information 60 may include, for example, information such as the diagnosis result 45 itself, driving support information corresponding to the diagnosis result 45, and information on recommended equipment. The driving support information is, for example, advice for improving driving of a negative evaluation (attention item). The recommended equipment is, for example, equipment that supports the operation of a negative evaluation (attention item). The equipment may be hardware such as an omnidirectional monitor, or may be software installed in the in-vehicle device 2, the user terminal 3, or the like to support driving. The data format of the information 60 may be appropriately selected according to the embodiment. The information 60 may include, for example, a sentence, a numerical value, a graph, a table, a diagram, etc. Note that the set notification format 50 may also be applied to notify other information other than the information 60 related to the diagnosis result 45.

### Two Configuration Examples

FIG. 3 schematically illustrates an example of a hardware configuration of the server device 1 according to the present embodiment. The server device 1 according to the present embodiment is a computer in which the control unit 11, the storage unit 12, the communication interface 13, and the drive 14 are electrically connected to each other.

The control unit 11 includes CPU (Central Processing Unit), RAM (Random Access Memory), ROM (Read Only Memory), and the like, and is configured to execute any information processing based on programs and various types of data. The control unit 11 (CPU) is an exemplary processor resource.

The storage unit 12 may be constituted by an arbitrary storage device such as a hard disk drive or a solid state drive, for example. The storage unit 12 (and RAM, ROM) is an exemplary memory-resource. In the present embodiment, the storage unit 12 stores various types of information such as the program 81, the diagnosis result 45, and the setting data 500.

The program 81 is a program for causing the server device 1 to execute information processing (FIG. 4 described later) related to the setting of the notification format 50. The program 81 includes a series of instructions for the information processing. The setting data 500 indicates the set notification format 50. The diagnostic data 45 and the setting data 500 may be held for each user OU.

The communication interface 13 is configured to perform wired or wireless data communication via a network. The communication interface 13 may be configured by, for example, a wired LAN (Local Area Network) module, a radio LAN module, or the like. In the present embodiment, the server device 1 may perform data communication with another computer (for example, the in-vehicle device 2, the user terminal 3, or the like) via a network using the communication interface 13.

The drive 14 is a device for reading various kinds of information such as a program stored in the storage medium 91. At least one of the program 81, the diagnosis result 45, and the setting data 500 may be stored in the storage medium 91 instead of the storage unit 12 or together with the storage unit 12. The storage medium 91 is configured to store various kinds of information (such as stored programs) by electrical, magnetic, optical, mechanical or chemical action so that a machine such as a computer can read the information. The server device 1 may acquire at least one of the program 81, the diagnosis result 45, and the setting data 500 from the storage medium 91. Note that the storage medium 91 may be a disk-type storage medium such as a CD, DVD, or may be a storage medium other than a disk-type such as a semiconductor memory (for example, a flash memory). The type of the drive 14 may be appropriately selected according to the type of the storage medium 91.

Regarding the specific hardware configuration of the server device 1, it is possible to omit, replace, and add constituent elements as appropriate according to the embodiment. For example, the control unit 11 may include a plurality of hardware processors. Hardware processors may be configured by microprocessors, FPGA (field-programmable gate array), DSP (digital signal processor), etc. The hardware processor may be configured by ECU (Electronic Control Unit), GPU (Graphics Processing Unit), ASIC (application specific integrated circuit), and the like. The drive 14 may be omitted. The server device 1 may be a general-purpose server device, a general-purpose PC, or the like, in addition to a computer designed exclusively for a service to be provided.

### 3 Operation Example

FIG. 4 is a flowchart illustrating an example of a processing procedure of the server device 1 according to the present embodiment. The control unit 11 of the server device 1 executes a command included in the program 81 by a CPU. Thus, the server device 1 operates as a computer capable of executing the following information processing. The following processing procedure is an example of an information processing method executed by a computer. However, the following processing procedure is merely an example, and each step may be changed as much as possible. Further, the following processing procedures can be omitted, replaced, and added as appropriate according to the embodiment.

In S101, the control unit 11 sets the notification format 50 in accordance with the diagnosis result 45 of the driving characteristic obtained from the driving data 40. In an example, setting the notification format 50 may include setting at least one of a notification destination, a notification timing, a number of items of information to be notified, a type of an item of information to be notified, and a representation format. In addition, in an exemplary embodiment, the control unit 11 may estimate the personality of the user OU from the diagnosis result 45 of the driving characteristic, and set the notification format 50 according to the personality of the estimated user OU. Alternatively, the control unit 11 may directly set the notification format 50 from the diagnosis result 45 of the driving characteristic.

In S102, the control unit 11 notifies the user OU of the information 60 related to the diagnosis result 45 in accordance with the set notification format 50. In an example, the information 60 may include at least one of the diagnosis result 45, the driving assistance information corresponding to the diagnosis result 45, and the recommended equipment information.

When the notification of the information 60 is completed, the control unit 11 ends the processing procedure of the server device 1 according to this operation example. Note that the control unit 11 may repeatedly execute a series of information processing of S101 and S102 at any timing. Further, the processes of S101 and S102 do not necessarily have to be executed continuously. S101 and S102 processes may be performed individually. The control unit 11 may repeatedly execute S102 process two or more times after executing S101 process once.

### Features

In the present embodiment, in the process of S101, it is possible to expect to set the notification format 50 conforming to the acceptability of the user OU in accordance with the diagnosis result 45 of the driving characteristic. Thus, in S102 process, the information 60 can be provided in the notification format 50 conforming to the acceptability of the user OU, and consequently, the information can be provided efficiently.

### 4 Modification

While embodiments of the present disclosure have been described in detail above, the foregoing description is merely illustrative of the present disclosure in all respects. The processing and units described in the present disclosure can be freely combined and implemented as long as there is no technical contradiction. Further, in the above-described embodiment, various improvements or modifications may be made as appropriate.

For example, in the above-described embodiment, the server device 1 is an example of an information processing device. However, the form of the information processing device is not limited to such an example, and may be appropriately changed according to the embodiment. In another example, at least one of the in-vehicle device 2 and the user terminal 3 may operate as an example of an information processing device.

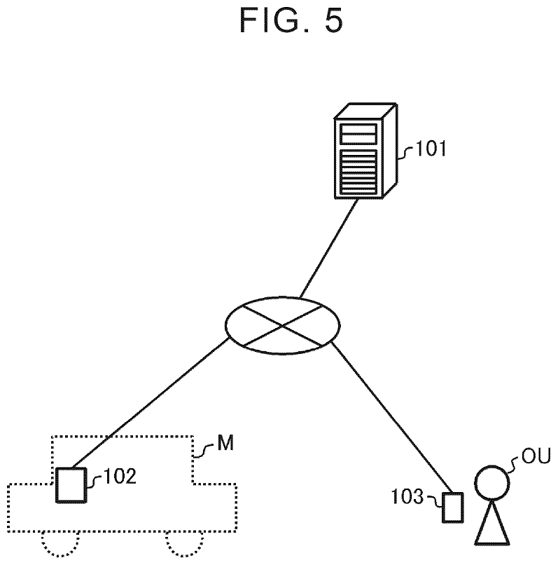

FIG. 5 schematically illustrates another example of a scene to which the present disclosure is applied. In the example of FIG. 5, the server device 101 corresponds to the server device 1, the in-vehicle device 102 corresponds to the in-vehicle device 2, and the user terminal 103 corresponds to the user terminal 3. An example of the hardware configuration of the in-vehicle device 102 and the user terminal 103 may be the same as that of the server device 1.

In an example, the in-vehicle device 102 may operate as an example of an information processing device. The in-vehicle device 102 may set the notification format 50 in accordance with the diagnosis result 45, and may output the information 60 to the user OU in accordance with the set notification format 50. The in-vehicle device 102 may output the information 60 to itself or to the user terminal 103. When outputting to the user terminal 103, the in-vehicle device 102 may indirectly transmit the information 60 to the user terminal 103 via the server device 101, or may directly transmit the information 60 to the user terminal 103.

In another example, the user terminal 103 may operate as an example of an information processing device. The user terminal 103 may set the notification format 50 in accordance with the diagnosis result 45, and may output the information 60 to the user OU in accordance with the set notification format 50. The user terminal 103 may output the information 60 to itself or the in-vehicle device 102. When outputting to the in-vehicle device 102, the user terminal 103 may indirectly transmit the information 60 to the in-vehicle device 102 via the server device 101, or may directly transmit the information 60 to the in-vehicle device 102. When the server device 101 is not used in the process of setting the notification format 50 and outputting the information 60, the server device 101 may be omitted.

What is claimed is:

1. An information processing device comprising a control unit configured to:
set a notification format according to a result of diagnosing a driving characteristic of a user from driving data related to driving of a vehicle; and
notify the user of information associated with the result of diagnosing the driving characteristic according to the set notification format.

2. The information processing device according to claim 1, wherein the setting of the notification format includes setting a notification destination.

3. The information processing device according to claim 1, wherein the setting of the notification format includes setting a notification timing.

4. The information processing device according to claim 1, wherein the setting of the notification format includes setting a number of items of information that the user is to be notified.

5. The information processing device according to claim 1, wherein the setting of the notification format includes setting a type of an item of information that the user is to be notified.
